(19) United States
(12) Patent Application Publication
(10) Pub. No.: US 2009/0096621 A1
(43) Pub. Date: Apr. 16, 2009

(54) SYSTEMS AND METHODS FOR CONFIGURING NOTIFICATION MESSAGES ABOUT ELECTRONIC DEVICE CONDITIONS

(75) Inventor: Andrew Rodney Ferlitsch, Camas, WA (US)

Correspondence Address: AUSTIN RAPP & HARDMAN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/870,557

(22) Filed: Oct. 11, 2007

(51) Int. Cl. G08B 21/00

(52) U.S. Cl. 340/635

(57) ABSTRACT

In accordance with a method for configuring notification messages about electronic device conditions, at least one recipient that is associated with a condition of an electronic device may be determined. A notification message may be created. The notification message may include a condition identifier and authorization information. The condition identifier may identify the condition, and the authorization information may indicate whether the at least one recipient is authorized to respond to the condition and what response actions the at least one recipient is authorized to perform. The notification message may be sent to the at least one recipient.

### TECHNICAL FIELD

The present disclosure relates generally to electronic devices. More specifically, the present disclosure relates to systems and methods for configuring notification messages about electronic device conditions.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers may vary in sophistication from one microcontroller to a fully-functional complete computer system. For example, small computers may be a one-chip computer, such as a microcontroller, a one-board type of computer, such as a controller, a typical desktop computer, etc.

Computers typically have one or more processors. The processor(s) usually are interconnected to different external inputs and outputs and function to manage the particular computer or device. Many appliances, devices, etc., include one or more small computers. Computer software runs the processors of these computers and tells the processors what to do to carry out certain tasks.

Multi-function peripheral (MFP) devices are examples of electronic devices. Examples of MFP devices include printers, copiers, scanners, facsimile devices, filing devices, publishing devices, audiovisual (A/V) recording/playback devices, duplication devices (e.g., CD/DVD), computers (clients, servers, etc.), mobile devices (e.g., personal digital assistants (PDAs), cellphones, etc.), household appliances (e.g., washers, dryers, ovens, etc.), and so forth.

As indicated above, the present disclosure relates generally to electronic devices. More specifically, the present disclosure relates to systems and methods for configuring notification messages about electronic device conditions.

### BRIEF DESCRIPTION OF THE DRAWINGS

FIG. 1 illustrates a multi-function peripheral (MFP) device for configuring alert notification messages;

FIG. 2 illustrates an MFP device sending an alert notification message to alert recipients;

FIG. 3 illustrates an MFP device receiving a response message from an alert recipient;

FIG. 4 illustrates a method for notifying alert recipients about an alert condition;

FIG. 5 illustrates a method for handling a response message that is sent by an alert recipient;

FIG. 6 illustrates a method for validating a response message;

FIG. 7 illustrates an MFP device sending an alert to a configured destination;

FIG. 8 illustrates an example of a user interface of an MFP device that may be used for configuring alert notification messages;

FIG. 9 illustrates an MFP device detecting the occurrence of an alert condition and sending an alert notification message to an alert recipient;

FIG. 10 illustrates an alert recipient responding to an alert notification message by sending a response message to the MFP device; and

FIG. 11 illustrates various components that may be utilized in an electronic device, such as an MFP device.

### DETAILED DESCRIPTION

A method for configuring notification messages about electronic device conditions is disclosed. The method may include determining at least one recipient that is associated with a condition of an electronic device. The method may also include creating a notification message that includes a condition identifier and authorization information. The condition identifier may identify the condition, and the authorization information may indicate whether the at least one recipient is authorized to respond to the condition and what response actions the at least one recipient is authorized to perform. The method may also include sending the notification message to the at least one recipient.

The condition may be an alert condition. The notification message may be an alert notification message.

The method may also include determining the authorization information. The authorization information may be determined by accessing configuration information.

The method may also include accessing configuration information to determine a notification communication type and a notification communication format for communication with the at least one recipient. The notification message may be sent in accordance with the notification communication type and the notification communication format.

The notification message may indicate a response communication type for responding to the notification message. The notification message may also indicate a response communication format for responding to the notification message.

The notification message may be sent in response to detecting the occurrence of the condition. Alternatively, the notification message may be sent as part of a periodic transmission of notification messages.

The method may also include receiving a response message that includes a command to perform at least one action. The method may also include attempting to validate the response message. The method may also include performing the at least one action if the response message is successfully validated.

Validating the response message may include verifying that the response message was sent in response to the notification message. Validating the response message may also include verifying that the response message was sent by an intended recipient of the notification message. Validating the response message may also include verifying that the sender of the response message is authorized to respond to the notification message. Validating the response message may also include verifying that the sender of the response message is authorized to perform the at least one action. Validating the response message may also include verifying that the at least one action is supported by the electronic device.

An electronic device for configuring notification messages corresponding to electronic device conditions is also disclosed. The electronic device may include a processor and memory in electronic communication with the processor. Instructions may be stored in the memory. The instructions may be executable to determine at least one recipient that is associated with a condition of an electronic device. The instructions may also be executable to create a notification message that includes a condition identifier and authorization information. The condition identifier may identify the condition. The authorization information may indicate whether the at least one recipient is authorized to respond to the condition and what response actions the at least one recipient is authorized to perform. The instructions may also be executable to send the notification message to the at least one recipient.

A computer-readable medium is also disclosed. The computer-readable medium may include executable instructions for determining at least one recipient that is associated with a condition of an electronic device. The computer-readable medium may also include executable instructions for creating a notification message that includes a condition identifier and authorization information. The condition identifier may identify the condition. The authorization information may indicate whether the at least one recipient is authorized to respond to the condition and what response actions the at least one recipient is authorized to perform. The computer-readable medium may also include executable instructions for sending the notification message to the at least one recipient.

As indicated above, the present disclosure relates generally to electronic devices. Multi-function peripheral (MFP) devices are examples of electronic devices. Examples of MFP devices include printers, copiers, scanners, facsimile devices, filing devices, publishing devices, audiovisual (A/V) recording/playback devices, duplication devices (e.g., CD/DVD), computers (clients, servers, etc.), mobile devices (e.g., personal digital assistants (PDAs), cellphones, etc.), household appliances (e.g., washers, dryers, ovens, etc.), and so forth.

When a dealer leases an MFP to a merchant or customer, the dealer may provide support when the MFP malfunctions. To control costs, the dealer may desire a system that can quickly and directly notify the dealer of a problem and details about the problem. Additionally, the dealer may also desire that the system supports a means of notifying the customer of problems, when the problem could be fixed by the customer (as opposed to the overhead cost of a dealer visit or remote intervention). Additionally, it may be desirable for the dealer or customer to further configure the notifications to indicate if the recipient has the authority to perform a remote initiated action (e.g., reboot) in response to the notification.

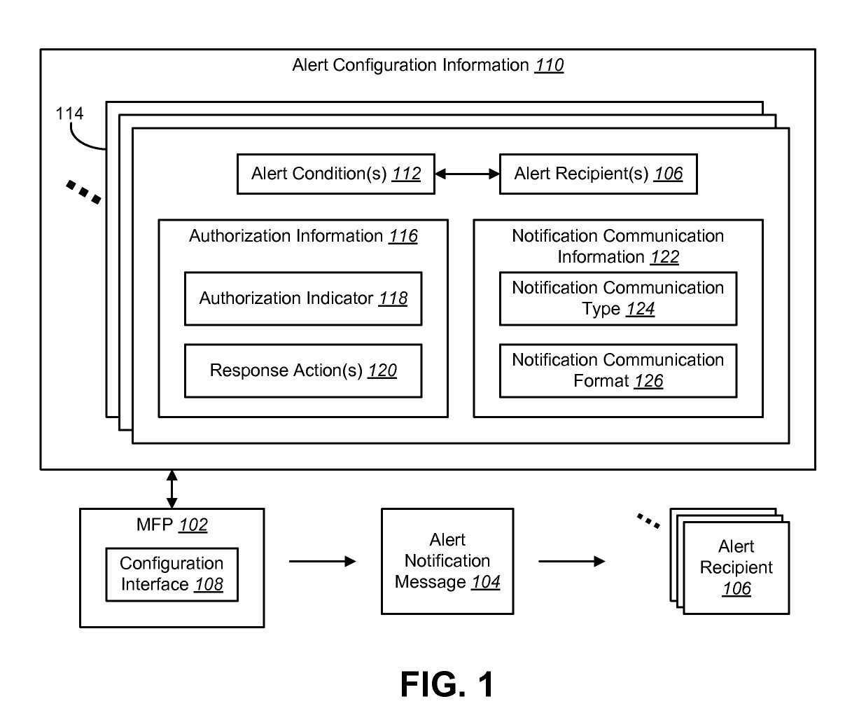

FIG. 1 illustrates a multi-function peripheral (MFP) device 102 for configuring alert notification messages 104. The MFP device 102 is capable of detecting and/or monitoring alert conditions 112 and sending alert notification messages 104 to alert recipients 106. The alert recipients 106 may be remote to the MFP device 102.

Many different kinds of alert conditions 112 may be monitored and/or detected. Examples of alert conditions 112 include a paper jam, whether the MFP device 102 has run out of a consumable (e.g., paper, ink, etc.), whether the MFP device 102 has a consumable that is at a low level, whether the door and/or cover of the MFP device 102 is open, whether the MFP device 102 is online and/or offline, whether the MFP device 102 has malfunctioned, whether it is time for service of the MFP device 102 based on a service maintenance cycle, whether the MFP device 102 has been compromised by a virus, malware or other malicious code, data or action, job completion and/or interrupt status, accounting, auditing, etc.

The MFP device 102 also includes a mechanism for an administrator to configure alert notification messages 104. The MFP device 102 is shown with a configuration interface 108. The configuration interface 108 may be, for example, a front panel, web page, a remote front panel, etc. An administrator (or other user of the MFP device 102) may access the configuration interface 108 for configuring the alert notification messages 104.

The MFP device 102 is shown storing alert configuration information 110. The alert configuration information 110 may be stored within the MFP device 102, on removable storage, on external storage, on an external datastore service, etc. The alert configuration information 110 may be updated whenever the administrator modifies the way that the sending of the alert notification messages 104 is configured.

An administrator may configure the sending of alert notification messages 104 for an alert recipient 106 by type. For example, alert recipient A may be configured to receive alert notification messages 104 for alerts 1, 2, and 3, while alert recipient B may be configured to receive alert notification messages 104 for alerts 1, 4 and 5.

The alert configuration information 110 is shown with multiple records 114. As used herein, the term “record” should be construed broadly to encompass any way in which information may be organized so as to create associations between related items of information. In this context, each record 114 corresponds to an association between one or more alert conditions 112 and one or more alert recipients 106.

Each record 114 includes authorization information 116. That is, the authorization information 116 corresponds to the one or more alert conditions 112 and the one or more alert recipients 106 of the record 114. The authorization information 116 includes an authorization indicator 118, which indicates whether the alert recipient(s) 106 is/are authorized to respond to the alert condition(s) 112.

The authorization information 116 also indicates what response action(s) 120 the alert recipient(s) 106 is/are authorized to perform. Examples of response actions 120 include rebooting the MFP device 102, taking the MFP device 102 offline, placing the MFP device 102 online, restarting a job, canceling a job, purging a job, purging memory, resetting the MFP device 102, downloading data and/or information, deleting data and/or information, uploading firmware, performing a billing correction, etc.

Each record 114 includes notification communication information 122. The notification communication information 122 is related to the communication of alert notification messages 104 to alert recipients 106.

The notification communication information 122 includes a notification communication type 124 and a notification communication format 126. The notification communication type 124 may indicate a type of communication that may be used for sending alert notification messages 104 to alert recipient(s) 106. The notification communication format 126 may indicate a communication format that may be used for sending alert notification messages 104 to alert recipient(s) 106.

Examples of the notification communication type 124 include email, instant messaging (IM), HTTP, SOAP/XML, SMS/MMS, a proprietary TCP/IP protocol, etc. Examples of the notification communication format 126 include plain text, HTML, PDF, XML, XPS, etc. Although just one notification communication type 124 and one notification communication format 126 are shown in FIG. 1, multiple notification communication types 124 and/or multiple notification communication formats 126 may be specified in a record 114 (i.e., associated with one or more alert conditions 112 and one or more alert recipients 106).

The authorization information 116 and the notification communication information 122 may be configured for all alert conditions 112 for a specific alert recipient 106. Alternatively, the authorization information 116 and the notification communication information 122 may be configured per alert condition 112 per alert recipient 106. Alternatively, the authorization information 116 and the notification communication information 122 may be configured per group of alert conditions 112 across alert recipients 106. Alternatively, the authorization information 116 and the notification communication information 122 may be configured per group of alert recipients 106 across alert conditions 112.

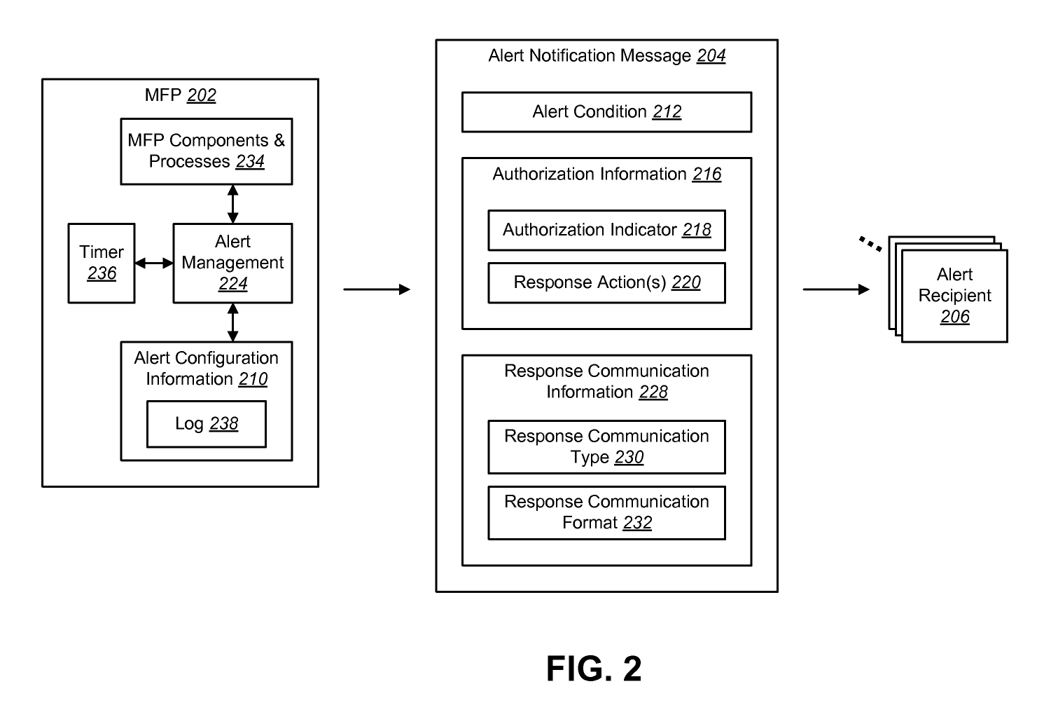

FIG. 2 illustrates an MFP device 202 sending an alert notification message 204 to one or more alert recipients 206. The alert notification message 204 specifies that a particular alert condition 212 has occurred.

The alert notification message 204 also includes authorization information 216. The authorization information 216 may be determined by accessing the alert configuration information 210. For example, the authorization information 216 may be determined by accessing the record 114 that is associated with the alert condition 212 and the alert recipient(s) 206.

The authorization information 216 includes an authorization indicator 218 that indicates whether the alert recipient(s) 206 is/are authorized to respond to the alert condition 212. The authorization information 216 also indicates what response action(s) 220 the alert recipient(s) 206 is/are authorized to perform.

The alert notification message 204 also includes response communication information 228. The response communication information 228 is related to the communication of responses to the alert notification message 204, i.e., responses sent from an alert recipient 206 to the MFP device 202.

The response communication information 228 includes a response communication type 230 and a response communication format 232. The response communication type 230 may indicate a type of communication that may be used for responding to the alert notification message 204. The response communication format 232 may indicate a communication format that may be used for responding to the alert notification message 204.

Examples of the response communication type 230 include email, instant messaging (IM), HTTP, SOAP/XML, SMS/MMS, a proprietary TCP/IP protocol, etc. Examples of the response communication format 232 include plain text, HTML, PDF, XML, XPS, etc.

Although just one response communication type 230 and one response communication format 232 are shown in FIG. 2, multiple response communication types 230 and/or multiple response communication formats 232 may be specified in an alert notification message 204. Where multiple response communication types 230 and/or multiple response communication formats 232 are specified, the alert notification message 204 may provide information that may assist the alert recipient 206 to select an appropriate response communication type 230 and/or an appropriate response communication format 232 (e.g., a rating, priority, etc.).

The alert notification message 204 may be sent in response to detecting the occurrence of the alert condition 212. MFP components and processes 234 may be monitored for the purpose of detecting the occurrence of alert conditions 212.

Alternatively, the alert notification message 204 may be sent as part of a periodic transmission of alert notification messages 204. For example, alert notification messages 204 may be sent whenever a periodic timer 236 expires. If alert notification messages 204 are sent periodically, alert conditions 212 may be grouped together (per alert recipient 206) with or without historical information over the periodic time period.

FIG. 2 illustrates the MFP device 202 sending a single alert notification message 204. However, under some circumstances multiple alert notification messages 204 may be sent. For example, multiple alert notification messages 204 may be sent if multiple alert conditions 212 exist. If multiple alert conditions 212 exist, the MFP device 202 may send alert notification messages 204 individually or bundled to the alert recipient(s) 206.

The MFP device 202 includes an alert management component 224. The alert management component 224 may be configured to manage the sending of alert notification messages 204 to alert recipients 206.

The MFP device 202 may also record, temporarily or permanently, to whom and when alert notification messages 204 are sent. This information may be recorded in a log 238, which may be part of the alert configuration information 210 that is stored.

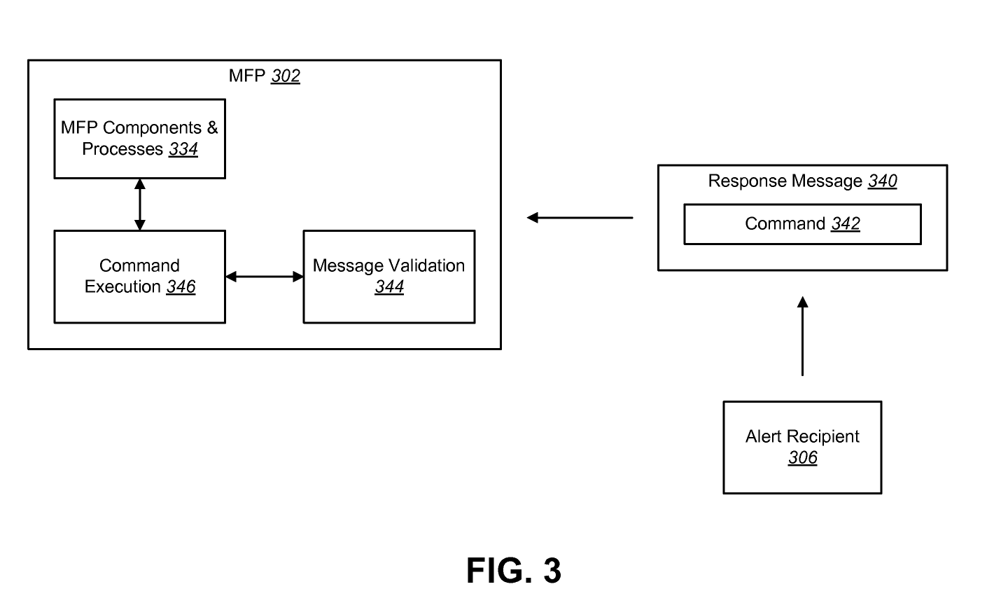

FIG. 3 illustrates an MFP device 302 receiving a response message 340 from an alert recipient 306. The sending of the response message 340 may be automatically or manually initiated.

When an alert recipient 306 receives an alert notification message 104, the alert recipient 306 may decide whether to respond to the alert notification message 104, and (assuming that the decision is made to respond) how to respond to the alert notification message 104. These decisions may be based on the authorization information 116 in the alert notification message 104. Alternatively, or in addition, the alert recipients 306 may make these decisions on their own.

The response message 340 may include a command 342 to perform at least one action that is related to addressing the alert condition 112 that is specified in the alert notification message 104. Examples of such actions include rebooting the MFP device 302, taking the MFP device 302 offline, placing the MFP device 302 online, taking a component or process of the MFP device 302 offline or online, restarting a job, canceling a job, purging a job, purging memory, resetting the MFP device 302, downloading data and/or information, deleting data and/or information, uploading firmware, performing a billing correction, locking down the MFP device 302, etc.

The response message 340 may be sent in accordance with the response communication information 228 in the alert notification message 204. If the response communication information 228 includes multiple response communication types 230 and/or multiple response communication formats 232, the alert recipient 306 may select the appropriate response communication type 230 and/or the appropriate response communication format 232 to use. The communication type and/or the communication format that is used to send the response message 340 may be the same or different than the communication type and/or the communication format that was used to send the alert notification message 104.

When the MFP device 302 receives the response message 340, the MFP device 302 may attempt to validate the response message 340. A message validation component 344 is shown in FIG. 3.

If the response message 340 is successfully validated, the MFP device 302 may perform the action(s) corresponding to the command(s) 342 in the response message 340. A command execution component 346 is shown in FIG. 3. The command execution component 346 may interact with other MFP components and processes 334 to perform the action(s) corresponding to the command(s) 342.

If the response message 340 is not successfully validated, the MFP device 302 may not perform the action(s) corresponding to the command(s) 342 in the response message 340. For example, the MFP device 302 may simply ignore any response messages 340 that are not successfully validated.

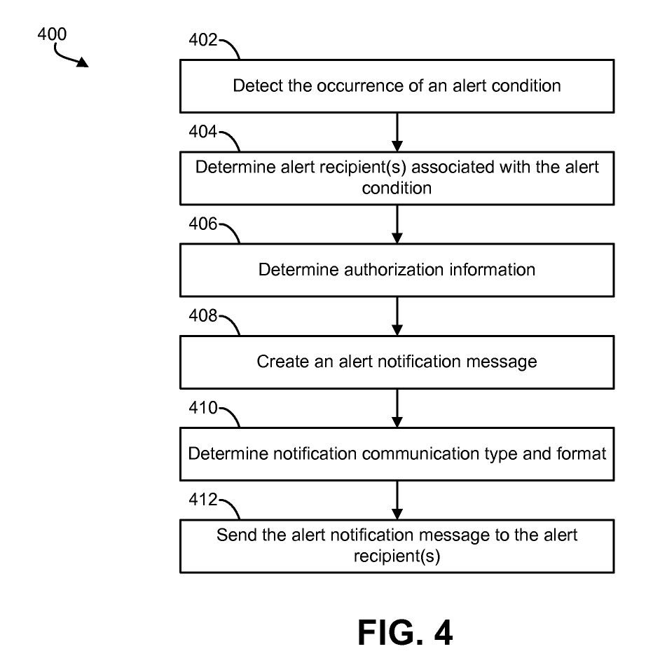

FIG. 4 illustrates a method 400 for notifying one or more alert recipients 106 about an alert condition 112. The method 400 may be performed by a multi-function peripheral (MFP) device 102.

At some point, the occurrence of an alert condition 112 may be detected 402. The remainder of the method 400 may be performed in response to the alert condition 112 being detected 402.

One or more alert recipients 106 that is/are associated with the alert condition 112 may be determined 404. This may be accomplished by accessing alert configuration information 110.

Authorization information 116 may be determined 406. The authorization information 116 corresponds to the alert condition 112 that is detected 402 and to the alert recipient(s) 106 that are supposed to be notified about the alert condition 112. The authorization information 116 may be determined 406 by accessing the alert configuration information 110.

An alert notification message 104 may be created 408. The alert notification message 104 may include authorization information 116. The alert notification message 104 may also include response communication information 228.

The notification communication type 124 and the notification communication format 126 corresponding to the alert condition 112 and the alert recipient(s) 106 may be determined 410. This may be accomplished by accessing the alert configuration information 110. The alert notification message 104 may be sent 412 to the alert recipient(s) 106 in accordance with the notification communication type 124 and the notification communication format 126 that are determined 410.

In the method 400 of FIG. 4, the alert notification message 104 is sent 412 in response to detecting 402 the occurrence of the alert condition 112. Alternatively, the alert notification message 104 may be sent as part of a periodic transmission of alert notification messages 104.

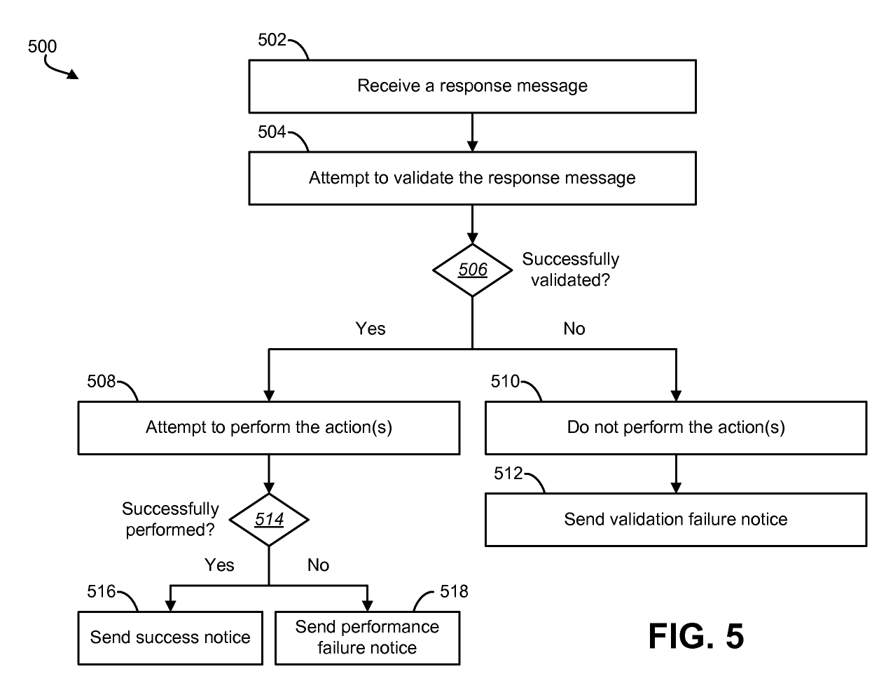

FIG. 5 illustrates a method 500 for handling a response message 340 that is sent by an alert recipient 106. The method 500 may be performed by a multi-function peripheral (MFP) device 102.

A response message 340 may be received 502. The response message 340 may include a command 342 to perform at least one action that is related to addressing an alert condition 112.

An attempt 504 may be made to validate the response message 340. It may then be determined 506 whether the response message 340 was successfully validated. If it is determined 506 that the response message 340 is not successfully validated, the action(s) corresponding to the command 342 may not be performed 510. A validation failure notice may be sent 512 to the sender.

If it is determined 506 that the response message 340 is successfully validated, an attempt may be made to perform 508 the action(s) corresponding to the command 342. It may then be determined 514 whether the action(s) corresponding to the command 342 were successfully performed. If it is determined 514 that the action(s) corresponding to the command 342 were successfully performed, then a success notice may be sent 516 to the sender. However, if it is determined 514 that the action(s) corresponding to the command 342 were not successfully performed, then a performance failure notice may be sent 518 to the sender.

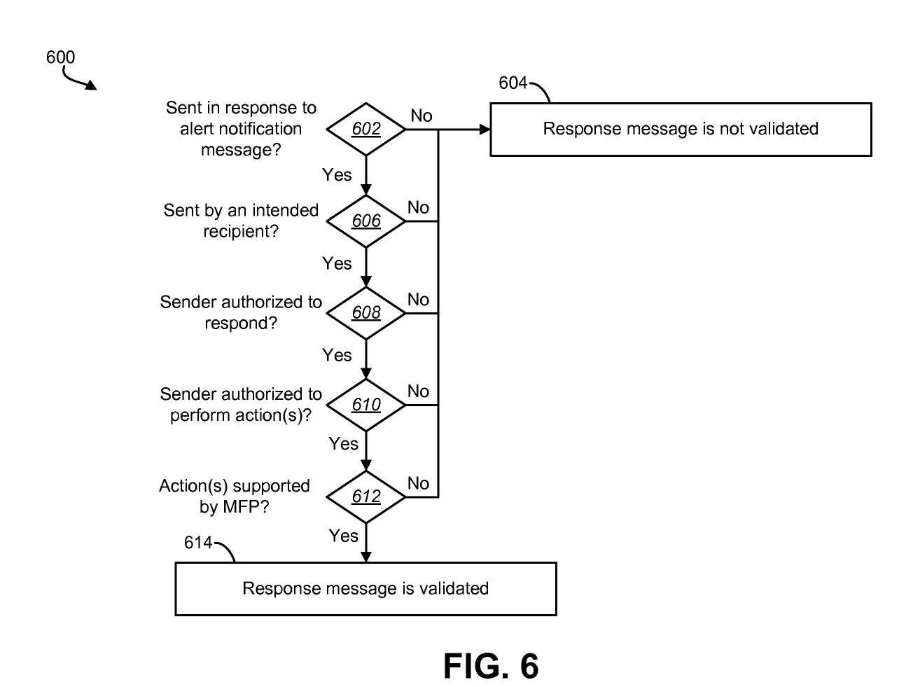

FIG. 6 illustrates a method 600 for validating a response message 340. The method 600 may be performed by a multi-function peripheral (MFP) device 102 in response to receiving a response message 340.

The method 600 may include determining 602 whether the response message 340 was sent in response to an alert notification message 104. If it is determined 602 that the response message 340 was not sent in response to an alert notification message 104, then it may be determined 604 that the response message 340 is not validated.

If it is determined 602 that the response message 340 was sent in response to an alert notification message 104, then it may be determined 606 whether the response message 340 was sent by an intended alert recipient 106. If it is determined 606 that the response message 340 was not sent by an intended alert recipient 106, then it may be determined 604 that the response message 340 is not validated.

If it is determined 606 that the response message 340 was sent by an intended alert recipient 106, then it may be determined 608 whether the sender of the response message 340 was authorized to respond to the alert notification message 104. If it is determined 608 that the sender of the response message 340 was not authorized to respond to the alert notification message 104, then it may be determined 604 that the response message 340 is not validated.

If it is determined 608 that the sender of the response message 340 was authorized to respond to the alert notification message 104, then it may be determined 610 whether the sender of the response message 340 is authorized to perform the action(s) corresponding to the command(s) 342 that are specified in the response message 340. If it is determined 610 that the sender of the response message 340 is not authorized to perform the specified action(s), then it may be determined 604 that the response message 340 is not validated.

If it is determined 610 that the sender of the response message 340 is authorized to perform the specified action(s), then it may be determined 612 whether the action(s) corresponding to the command(s) 342 are supported by the MFP device 302. If it is determined 612 that the action(s) corresponding to the command(s) 342 are not supported by the MFP device 302, then it may be determined 604 that the response message 340 is not validated. However, if it is determined 612 that the action(s) corresponding to the command(s) 342 are supported by the MFP device 302, then it may be determined 614 that the response message 340 is validated.

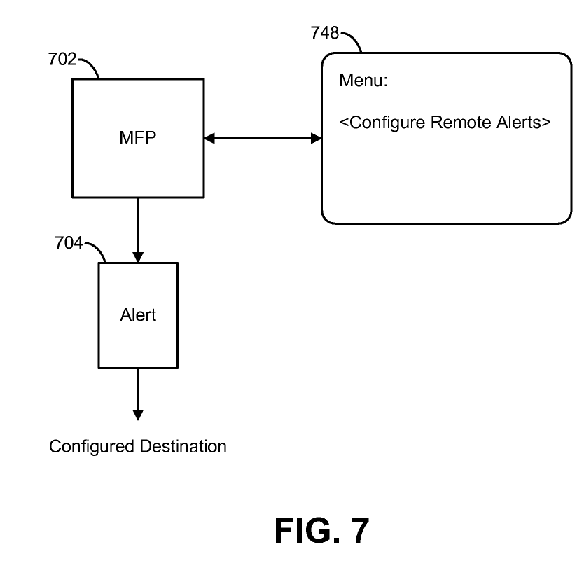

FIG. 7 illustrates an MFP device 702 sending an alert notification message 704 to a configured destination. A user interface 748 of the MFP device 702 is also shown. The user interface 748 includes a menu for configuring remote alerts. The user interface 748 may be one aspect of a configuration interface 108 that an MFP device 702 may have.

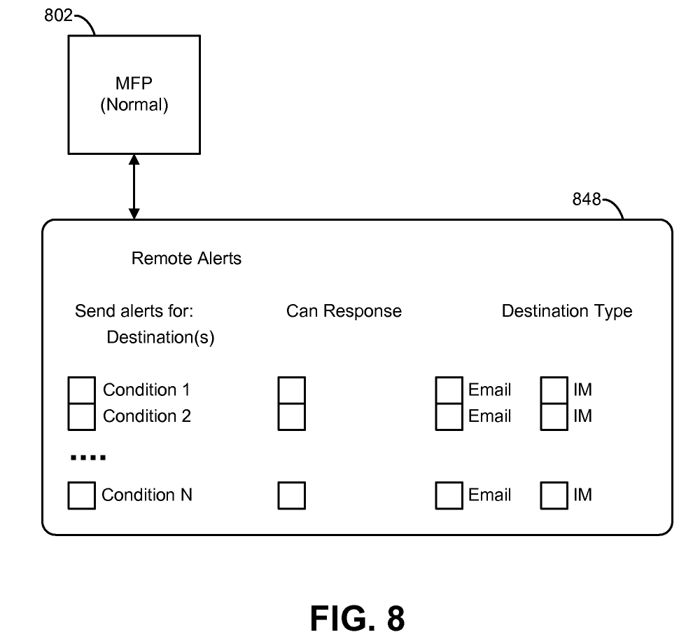

FIG. 8 illustrates an MFP device 802 operating in a normal state. FIG. 8 also illustrates a more detailed example of a user interface 848 of an MFP device 802. An administrator or other user of the MFP device 802 may configure the sending of alert notification messages 104 via the user interface 848. Information that is supplied via the user interface 848 may be stored in the alert configuration information 110.

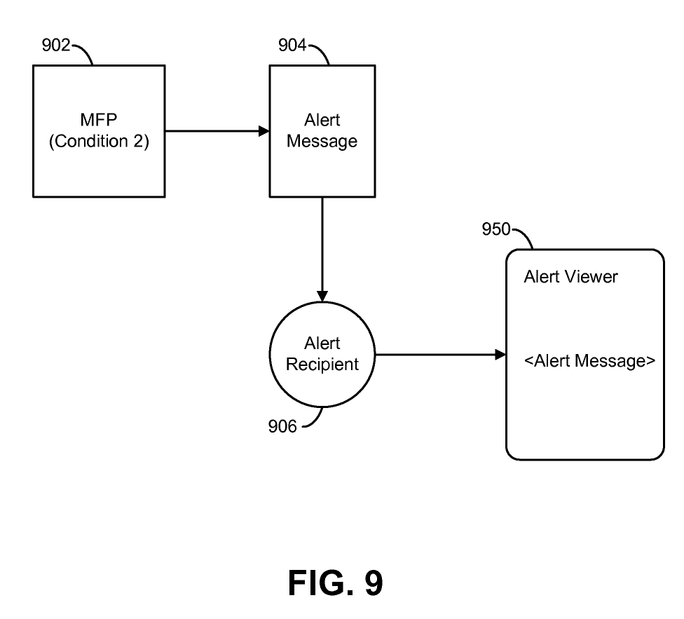

FIG. 9 illustrates an MFP device 902 detecting the occurrence of an alert condition 112, and sending an alert notification message 904 to an alert recipient 906 in response to detecting the alert condition 112. The alert recipient 906 may display at least some of the content of the alert notification message 904 via a user interface 950 of the alert recipient 906.

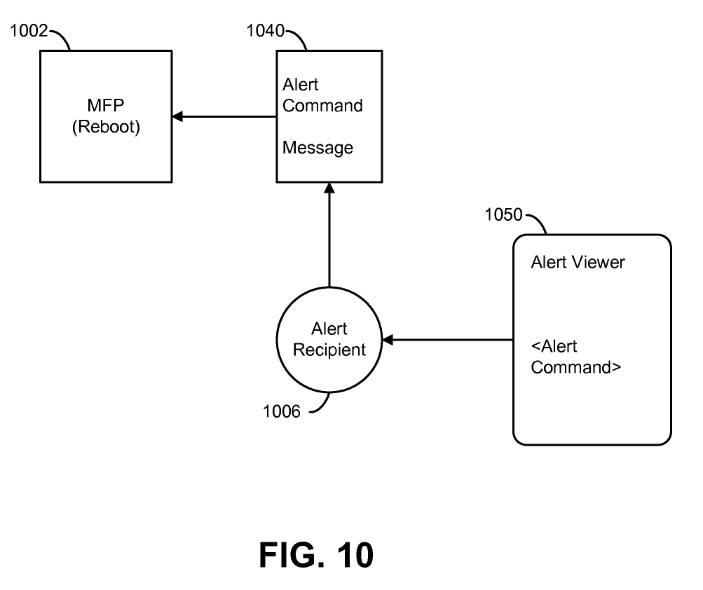

FIG. 10 illustrates an alert recipient 1006 responding to an alert notification message 104 by sending a response message 1040 to the MFP device 1002. The response message 1040 may include a command 342 to perform one or more actions related to addressing the alert condition 112. The command(s) 342 in the response message 1040 may be created via a user interface 1050 of the alert recipient 1006.

Although the above description has been related to alert conditions 112 and alert notification messages 104, the present disclosure is not limited in this regard. The present disclosure may be applied to any form of notifications which may go to one or more recipients and may have corresponding response actions. Also, the present disclosure may be applied to any type of electronic device, not just MFP devices 102.

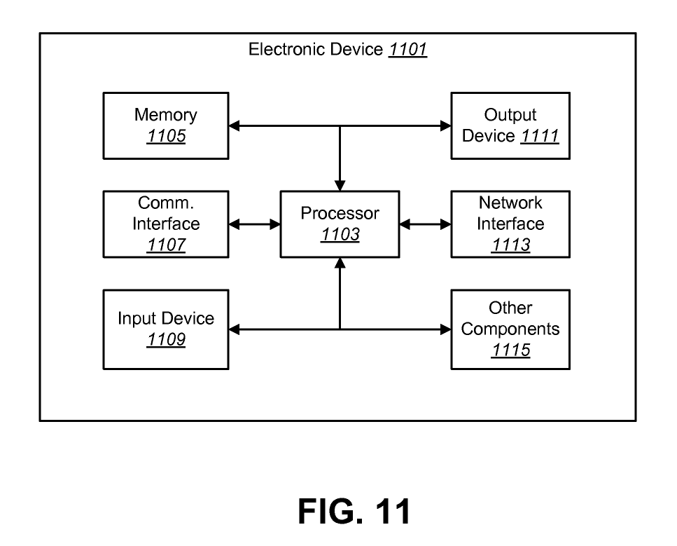

FIG. 11 illustrates various components that may be utilized in an electronic device 1101. An MFP device 102 is one example of an electronic device 1101. An MFP device 102 may include some or all of the components shown in FIG. 11.

The illustrated components may be located within the same physical structure or in separate housings or structures. Thus, the term electronic device 1101 includes one or more broadly defined computing devices unless it is expressly stated otherwise. Electronic devices may include the broad range of digital computers including microcontrollers, hand-held computers, personal computers, servers, mainframes, supercomputers, minicomputers, workstations, and any variation or related device thereof.

The electronic device 1101 is shown with a processor 1103 and memory 1105. The processor 1103 may control the operation of the electronic device 1101 and may be embodied as a microprocessor, a microcontroller, a digital signal processor (DSP) or other device known in the art. The processor 1103 typically performs logical and arithmetic operations based on program instructions stored within the memory 1105. The instructions in the memory 1105 may be executable to implement the methods described herein.

The electronic device 1101 may also include one or more communication interfaces 1107 and/or network interfaces 1113 for communicating with other electronic devices. The communication interface(s) 1107 and the network interface(s) 1113 may be based on wired communication technology, wireless communication technology, or both.

The electronic device 1101 may also include one or more input devices 1109 and one or more output devices 1111. The input devices 1109 and output devices 1111 may facilitate user input. Other components 1115 may also be provided as part of the electronic device 1101.

FIG. 11 illustrates only one possible configuration of an electronic device 1101. Various other architectures and components may be utilized.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems and methods described above without departing from the scope of the claims.

What is claimed is:

1. A method for configuring notification messages about electronic device conditions, comprising:
determining at least one recipient that is associated with a condition of an electronic device;
creating a notification message that comprises a condition identifier and authorization information, wherein the condition identifier identifies the condition, and wherein the authorization information indicates whether the at least one recipient is authorized to respond to the condition and what response actions the at least one recipient is authorized to perform; and
sending the notification message to the at least one recipient.

2. The method of claim 1, wherein the condition is an alert condition, and wherein the notification message is an alert notification message.

3. The method of claim 1, wherein the electronic device is a multi-function peripheral device.

4. The method of claim 1, further comprising determining the authorization information by accessing configuration information.

5. The method of claim 1, further comprising accessing configuration information to determine a notification communication type and a notification communication format for communication with the at least one recipient, wherein the notification message is sent in accordance with the notification communication type and the notification communication format.

6. The method of claim 1, wherein the notification message indicates a response communication type and a response communication format for responding to the notification message.

7. The method of claim 1, wherein the notification message is sent in response to detecting the occurrence of the condition.

8. The method of claim 1, wherein the notification message is sent as part of a periodic transmission of notification messages.

9. The method of claim 1, further comprising:
receiving a response message that comprises a command to perform at least one action;
attempting to validate the response message; and
performing the at least one action if the response message is successfully validated.

10. The method of claim 9, wherein validating the response message comprises:
verifying that the response message was sent in response to the notification message;
verifying that the response message was sent by an intended recipient of the notification message;
verifying that the sender of the response message is authorized to respond to the notification message;
verifying that the sender of the response message is authorized to perform the at least one action; and
verifying that the at least one action is supported by the electronic device.

11. An electronic device for configuring notification messages corresponding to electronic device conditions, comprising:
a processor;
memory in electronic communication with the processor;
instructions stored in the memory, the instructions being executable to:
determine at least one recipient that is associated with a condition of an electronic device;
create a notification message that comprises a condition identifier and authorization information, wherein the condition identifier identifies the condition, and wherein the authorization information indicates whether the at least one recipient is authorized to respond to the condition and what response actions the at least one recipient is authorized to perform; and
send the notification message to the at least one recipient.

12. The electronic device of claim 11, wherein the condition is an alert condition, and wherein the notification message is an alert notification message.

13. The electronic device of claim 11, wherein the electronic device is a multi-function peripheral device.

14. The electronic device of claim 11, wherein the instructions are also executable to determine the authorization information by accessing configuration information.

15. The electronic device of claim 11, wherein the instructions are also executable to:
receive a response message that comprises a command to perform at least one action;
attempt to validate the response message; and
perform the at least one action if the response message is successfully validated.

16. A computer-readable medium comprising executable instructions for:
determining at least one recipient that is associated with a condition of an electronic device;
creating a notification message that comprises a condition identifier and authorization information, wherein the condition identifier identifies the condition, and wherein the authorization information indicates whether the at least one recipient is authorized to respond to the condition and what response actions the at least one recipient is authorized to perform; and
sending the notification message to the at least one recipient.

17. The computer-readable medium of claim 16, wherein the condition is an alert condition, and wherein the notification message is an alert notification message.

18. The computer-readable medium of claim 16, wherein the electronic device is a multi-function peripheral device.

19. The computer-readable medium of claim 16, wherein the instructions are also executable for determining the authorization information by accessing configuration information.

20. The computer-readable medium of claim 16, wherein the instructions are also executable for:
receiving a response message that comprises a command to perform at least one action;
attempting to validate the response message; and
performing the at least one action if the response message is successfully validated.
